(19) United States
(12) Patent Application Publication
(10) Pub. No.: US 2017/0034006 A1
(43) Pub. Date: Feb. 2, 2017

(54) DYNAMIC RECONFIGURATION OF NETWORK TOPOLOGY FOR LOW-LATENCY MEDIA TRANSMISSIONS

(71) Applicant: Blackfire Research Corporation, San Francisco, CA (US)

(72) Inventor: Ravi Rajapakse, San Francisco, CA (US)

(21) Appl. No.: 15/294,596

(22) Filed: Oct. 14, 2016

Related U.S. Application Data
(63) Continuation-in-part of application No. 15/085,975, filed on Mar. 30, 2016.
(60) Provisional application No. 62/140,427, filed on Mar. 30, 2015.

(51) Int. Cl. H04L 12/24; H04W 28/02; H04L 12/26

(52) U.S. Cl. CPC H04L 41/12; H04L 41/0816; H04L 43/16; H04W 28/0236; H04W 84/18

(57) ABSTRACT

A system and method for dynamic reconfiguration of network topology for low-latency media transmissions. Under conditions where latency is not a large issue, the system establishes a standard infrastructure type wireless configuration. Under latency sensitive conditions such as the transmission of media that must be rendered synchronously, a topology of direct connection between the source device and rendering devices is chosen. When packet receipt issues between the source and one or more rendering devices occurs, the data pathway between network member devices is modified to re-establish reliable connection.

### CROSS-REFERENCE TO RELATED APPLICATIONS

This application is a continuation-in-part of U.S. patent application Ser. No. 15/085,975, titled “DYNAMIC RECONFIGURATION OF NETWORK TOPOLOGY FOR REDUCED LATENCY IN MEDIA TRANSMISSIONS”, and filed on Mar. 30, 2016, which claims the benefit of claims priority to U.S. provisional patent application Ser. No. 62/140,427, titled “Dynamic Reconfiguration of Network Topology For Reduced Latency In Media Transmissions” and filed on Mar. 30, 2015. The disclosure of the above-referenced patent application is incorporated herein by reference in its entirety.

### BACKGROUND OF THE INVENTION

Field of the Art

The disclosure relates to the field of wireless media playback systems, and more particularly to the field of using different wireless network topologies to reduce latency when delivering media to a plurality of devices.

Discussion of the State of the Art

In the design of a wireless media playback system, different use cases may benefit from or even require different wireless network topologies. In some products, a single device may need to support use cases with conflicting requirements of its underlying network topology.

As an example, one might imagine a “whole home” audio system where several speakers have been connected to a home Wi-Fi access point in what is called infrastructure mode. In this mode, all speakers are directly visible to and addressable by any other device on that same network, allowing them to be used and configured independently of each other. However, this topology has the disadvantage of requiring two network hops for data to move from any device to any other. This both increases the total utilization of the radio spectrum, and subjects all communications to increased possibility of interference and uncertainty compared to a topology involving only one network hop between devices.

While the whole home network infrastructure-mode topology is ideal for simplicity and flexibility, it is not ideal when “low latency” transmissions are required, for example, if the audio must be synchronized with video coming from a television which cannot be delayed. In this case, it would be advantageous, and possibly even necessary, to operate in a topology where all devices are directly connected.

What is needed is a wireless media playback system and method that may automatically reconfigure its network topology for low-latency communication such that two network hops for data to move from any device to any other is not needed.

### SUMMARY OF THE INVENTION

Accordingly, the inventor has conceived and reduced to practice, in a preferred embodiment of the invention, a system and method for dynamic reconfiguration of network topology for reduced latency in media transmissions.

Under conditions where latency is not a large issue, the invention establishes a standard infrastructure type wireless configuration. Under latency sensitive conditions such as the transmission of media that must be rendered synchronously, a topology utilizing direct connections between the source device and rendering devices is chosen. When packet receipt issues between the source and one or more rendering devices occurs, the data pathway between network member devices is modified to re-establish reliable connection.

According to a preferred embodiment of the invention, a system for dynamic reconfiguration of network topology for low-latency media transmissions, comprising: a topology manager comprising at least a plurality of programming instructions stored in a memory and operating on a processor of a network-connected computing device and configured to monitor a plurality of performance metrics of at least a wireless network, and configured to direct the operation of at least a wireless network interface, and configured to communicate with a plurality of external devices via the wireless network interface; wherein the topology manager directs the wireless network interface to operate in infrastructure mode if the monitored performance metrics do not exceed a quality-of-service threshold; and wherein the topology manager directs the wireless network interface to operate in ad hoc mode if at least a portion of the monitored performance metrics exceed a quality-of-service threshold, is disclosed.

According to another preferred embodiment of the invention, a method for dynamic reconfiguration of network topology for low-latency media transmissions, comprising the steps of: monitoring, using topology manager comprising at least a plurality of programming instructions stored in a memory and operating on a processor of a network-connected computing device and configured to monitor a plurality of performance metrics of at least a wireless network, and configured to direct the operation of at least a wireless network interface, and configured to communicate with a plurality of external devices via the wireless network interface, a plurality of network performance metrics for a wireless network; determining whether any of the monitored performance metrics exceed a quality-of-service threshold; and if a quality-of-service threshold is exceeded, directing at least the wireless network interface to operate in ad hoc mode, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is an architecture diagram of an exemplary system for dynamic reconfiguration of network topology for low-latency media transmissions according to a preferred embodiment of the invention, illustrating media transmission using a wireless network.

FIG. 2 is an architecture diagram of an exemplary system for dynamic reconfiguration of network topology for low-latency media transmissions according to a preferred embodiment of the invention, illustrating the configuration of a low-latency group within a wireless network.

FIG. 3 is an architecture diagram of an exemplary system for dynamic reconfiguration of network topology for low-latency media transmissions according to a preferred embodiment of the invention, illustrating the use of dual network adapters to manage a low-latency group.

FIG. 4 is an architecture diagram of an exemplary system for dynamic reconfiguration of network topology for low-latency media transmissions according to a preferred embodiment of the invention, illustrating the use of a media computing device and multiple speakers as a low-latency group within a home theater arrangement.

FIG. 5 is a block diagram illustrating an architecture for a state manager configured to manage application states, according to a preferred embodiment of the invention.

FIG. 6 is a flow diagram illustrating an exemplary method for dynamic reconfiguration of network topology for low-latency media transmissions according to a preferred embodiment of the invention.

FIG. 7 is a block diagram illustrating an exemplary hardware architecture of a computing device used in an embodiment of the invention.

FIG. 8 is a block diagram illustrating an exemplary logical architecture for a client device, according to an embodiment of the invention.

FIG. 9 is a block diagram showing an exemplary architectural arrangement of clients, servers, and external services, according to an embodiment of the invention.

FIG. 10 is another block diagram illustrating an exemplary hardware architecture of a computing device used in various embodiments of the invention.

### DETAILED DESCRIPTION

The inventor has conceived, and reduced to practice, a wireless media playback system and method that may automatically reconfigure their network topology for low-latency communication.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Conceptual Architecture

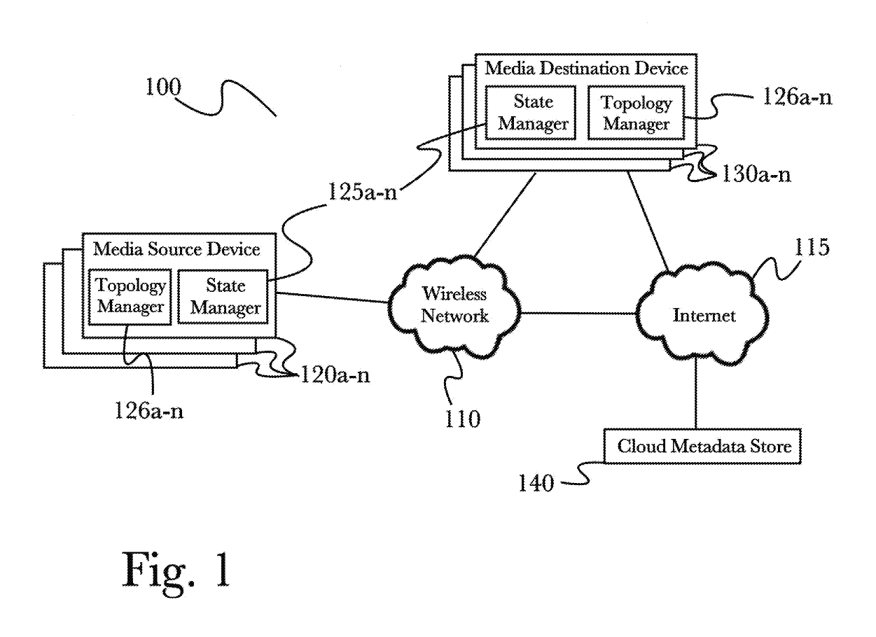

FIG. 1 is an architecture diagram of an exemplary system for dynamic reconfiguration of network topology for low-latency media transmissions according to a preferred embodiment of the invention, illustrating media transmission using a wireless network. According to the embodiment, system 100 may comprise a plurality of media source devices 120a-n, each of which may comprise any of a variety of computing devices that may originate digital media streams and, as such, may include computers (desktop, notebooks, tablet, handheld), mobile devices (including smartphones, wearable electronic devices, electronic book readers, organizer devices, and the like), as well as set top boxes and game machines. A media source device 120a-n may communicate via a wireless network 110, the may be any of a variety of wireless data communication network types using a variety of communication protocols, such as (for example) a wireless local area network (LAN) operating using Wi-Fi, or a cellular wide-area network (WAN). Wireless network 110 may be any network that supports internet protocol (IP) or other data communication protocols suitable for connecting and facilitating communication between a plurality of electronic devices. Additionally, as shown, some or all devices may communicate via the Internet 115, enabling communication between devices on separate local networks using the Internet 115 as a “bridge” between them. For example, “local” media source device 120a-n may connect to wireless network 110 to communicate with the Internet 115, in order to communicate with a “remote” media destination device 130a-n that may be connected to a separate wireless network 110 and communicating via the Internet 115, even when the two wireless networks may not be directly connected to one another.

The media referenced above may be any form of digital media that is made up of one or more of audio, video, data, generated speech, or other media that may be read, seen or heard on a suitable playback device. In some embodiments, the media may be a combination of one or more digital media sources.

A media destination device 130a-n may comprise any electronic device that may receive digital media over a data communication network such as the Internet (for example) and that may render or playback the received media. This includes, but is not limited to, IP-enabled audio and/or video devices that may render audio or video respectively, or both at the same time. A media destination device 130a-n may display text on a screen, according to the nature of a particular device, arrangement, or media content. If the media is audio, playing the media may comprise rendering as audio to which a user may listen, for example via a hardware speaker device. If the media is video, playing may comprise rendering the video such that a user may view the media, for example via a video display device such as an LCD screen. If the media includes both audio and video, playback may comprise rendering both the audio and the video simultaneously. If the media is text, playing may comprise rendering the text such that it is readable by a user, for example via an LCD or e-ink display screen.

A state manager 125a-n may be used by a media source device 120a-n to transmit state messages via network 110, for example to coordinate media playback with a plurality of media destination devices 130a-n or to probe for available media destination devices 130a-n that may be available for media rendering. Upon receiving a state management protocol message, an available media destination device 130a-n may respond with a state management protocol message using either wireless multicast to all available devices or wireless unicast to a particular device. A state management protocol response message may typically include a unique identifier, such as a transmitting device's hardware MAC address or another identifier, and may also include (for example including but not limited to) a device's playback capabilities such as audio, video, combinations of audio and video, or other possible playback capabilities; whether the sending device is currently playing media (playback state); the device's current playback volume level (volume state); media metadata display capabilities (metadata state) or a current active media source device, if the transmitting device is a media destination device currently engaged in playback.

In addition to sending media from media source devices 120a-n to media destination devices 130a-n, the state management protocol may be used to control state management parameters in a bi-directional manner between source and destination devices during operation. Examples of a state management message may include, but are not limited to, increase/decrease volume messages, metadata transmittal messages, playback source messages, and other messages that may communicate a device state, or any changes thereof, to another device. Messages may be sent as a broadcast or multicast message to multiple media destination devices 130a-n or as a unicast message to a specific media destination device 130a-n. In an example scenario, system 100 may be playing streaming media originating from one media source device 120a-n at one or more media destination devices 130a-n, when a second media source device 120a-n may then send a volume adjustment message to one or more media destination devices 130a-n, causing receiving devices to adjust their current playback volume state and, optionally, to update other media source devices 120a-n (optionally the originating media source device 120a-n) of their new updated state (via additional state messages).

According to another exemplary arrangement, system 100 may be playing streaming media originating from a media source device 120a-n at one or more media destination devices 130a-n. If a second media source device 120a-n initiates media playback to one or more media destination devices 130a-n, and the first media source device 120a-n is already playing to at least a portion of the media destination devices 130a-n, some or all of the portion of media destination devices 130a-n may notify, using state management protocol messages, the first media source device 120a-n of the request to initiate playback from the second media source device 120a-n and the first media source device 120a-n may then change its playback state in response to a received state message. The affected media source device(s) 120a-n may then, for example, change a playback state from “playing” to “stopped” or “paused”. Then the second media source device 120a-n may initiate playback and change its playback state from “stopped” or “paused” to “playing”. It should be appreciated that variations of these steps are possible according to various arrangement to accommodate various forms of media, device capabilities or arrangements, network structure or protocols, or other variations. For example, media destination devices 120a-n may begin playing back streaming media from the second media source device 120a-n even before the first media source device 120a-n changes its state and ceases streaming media-that is, media destination devices 120a-n may simply ignore the streaming media from the first media source device 120a-n, rather than waiting for notification that the first media source device 120a-n has ceased playing or streaming media.

In another exemplary arrangement, system 100 may be playing streaming media originating from a media source device 120a-n at one or more media destination devices 130a-n. When a first media source device 120a-n is playing media to one or more destination devices 130a-n, the media source device 120a-n may provide metadata about the media (for example, a media reference number, media name, artist, album information, or any other information that may be associated with, relevant to, or embedded within a media stream) to some or all receiving media destination devices 130a-n. Each of a plurality of receiving media destination devices 130a-n may optionally present one or more received metadata items to a user using any available means according to the nature or configuration of the particular device, for example via a connected or integral video display or as an audio announcement rendered using a speaker.

According to a further exemplary arrangement, if there is additional metadata information to be displayed at a media destination device 130a-n (for example, album art for music content), that was not included in metadata provided by a media source device 120a-n, the media destination device 130a-n may use information from the included metadata to get the additional metadata information from an online cloud-based metadata store 140 accessible via the Internet 115. Cloud metadata store 140 may comprise a music discovery service (for example SHAZAM™, MIDOMI™, AUDIOTAG™, SIRI™, or similar media service) that may be used by a media source 120a-n or destination 130a-n device to retrieve additional metadata information as needed. According to some arrangements, a “digital fingerprint” of the audio may be created or obtained (for example, from a store of known file fingerprint information) and matched against online databases of known media (for example, music tracks, TV shows, IMDB™, etc.) to retrieve additional metadata (for example, name of the track, TV show, Movie, publication, etc. lyrics, biographies, recommendations, etc.). Once recovered, additional metadata information may be shared with, and optionally stored on, a media source device 120a-n to speed future display, and optionally transmitted to other media destination devices 130a-n for display.

It should be appreciated that metadata may be received, stored, or presented as described above, either at a media destination device 130a-n or a media source device 120a-n, or both in various combinations when multiple devices are utilized. When metadata is presented or stored at a media source device 120a-n, the device may be the media source device 120a-n from which active media content originated or is being broadcast, or may optionally be another media source device that is not currently delivering media.

According to some arrangements, a media source device 120a-n may receive and broadcast media from an online music or video streaming source such as SPOTIFY™, PANDORA™, MISCLOUD™, RDIO™, ITUNES RADIO™, CBC ONLINE™, CNBC™, NETFLIX™, HBO-TO-GO™, or other such cloud-based media products or services. Streaming media from such sources may then be broadcast to a plurality of media destination devices 130a-n similar to locally-stored or produced media, as described above. Additionally, a media source device 120a-n may comprise a receiver device connected to a satellite radio, radio or TV antenna transmitting over-the-air (OTA) signals of regulated or unregulated radio or video transmissions, and may be used in this fashion to present media from broadcast stations or channels. A media source device 120a-n may also comprise an online podcast broadcasting service or a syndication of Web content via, for example, “rich site summary” also known as “really simple syndication” (RSS) feeds or similar syndication means. A media source device 120a-n may comprise a digital reader configured to display content from an online bookstore (for example, AMAZON™, BARNES & NOBLE™, CHAPTERS™, Project Gutenberg, GOOGLE BOOKS™, or other products or services for electronic book publishing, distribution, or sales), generally delivering media in the form of text, audio, or images from periodicals, novels, or other literature or publications. In other arrangements, a media source device 120a-n may operate a software application configured to display content from a social media platform (for example, TWITTER™, FACEBOOK™, LINKEDIN™, SNAPCHAT™, YOUTUBE™, etc.) where the media may be displayed on a screen (for example, on an e-reader device) as text or images, or alternately converted to another medium such as audio, for example by using text-to-speech (TTS). According to further exemplary arrangements, a media source device 120a-n may comprise a communication device such as a mobile phone receiving audio or video communication, voice-over-IP (VoIP) conversation, SKYPE™ chat or call, an IM or ICQ session, FACEBOOK™ chat, POTS conversation, or other forms of IP-based communication between users or user devices.

IP networks were first designed to operate over wired networks. By design, the packet communications on these networks were ‘best effort’. This means any packet transmitted on the network may not be received by the intended destination. This is most often due to a collision, where another device starts to communicate at the same moment as the device of interest, thereby causing a collision. Another method of loss may be that the devices in the network path, for example, a router or switch (not shown) operating on wireless network 110, simply drop the packet, for example due to the lack of buffer space. Other reasons for loss could be that the wired line is simply noisy and the packet transmission got corrupted. In all these wired situation, it is generally the case, that if the transmission (say a multicast message) was received by one media destination device 130a-n on a “subnet” or wire, all the other media destination devices 120a-n on the same ‘wire’ or subnet also receive the transmission correctly. This is because in the wired case, the noise or interference situation of a device on one part of the wire is not so different from the noise situation at another part of the wire.

However, in Wi-Fi the situation is more complex. In wireless, the noise, standing wave, reflection situation may change from one point to another (that is, one point that is a particular distance from a point in a wireless network 110 to another point, a different distance). Each device on the same subnet does not see the same RF environment as another device right next to it. This means that any transmission (again say a multicast message) will be received very differently at each Wi-Fi device in the same network—even if they are right next to each other. In Wi-Fi the differences in receipt of Wi-Fi traffic at each Wi-Fi device in a subnet is substantial. Therefore, it is necessary to account for this in system 100.

In a preferred embodiment, to account for the differences in Wi-Fi traffic receipt at each, various techniques may be used, for example, “Managed Receipt” where media source device 120a-n manages the receipt of media packets at each media destination device 130a-n. Topology manager 126a-n monitors the progress of packets between media source devices 120a-n and media destination devices 130a-n. Note any reference to the word ‘broadcast’ refers to the English meaning of the word as well as the IP communication methods of both broadcasting and multicasting. Broadcasting may also be implemented by unicasting IP packets to several destinations—which has the same effect as a broadcast, though it is not an efficient use of the network. Additionally, it should be appreciated that the word “packet” may be used in a general sense to mean any electronic data set.

Managed receipt accounts for the differences in RF signal and therefore Wi-Fi transmission receipt at each device in the Wi-Fi Subnet. The process for doing this requires retransmission of lost packets. The time it takes for a packet to be identified as lost at the destination, a loss notification being sent to the source and to topology manager 126a-n, the source may resend the packet and the retransmitted packet being received by the destination adds to the total system ‘latency’. For example, if it takes 100 mSecs for this process to occur, data receipt at the receiver will be delayed by 100 msecs. In order to keep this latency low, it is necessary to keep these delays as low as possible. In general, the transmission delays are low, in that they are not much more than the packet transmission times, for example, measured in 2-4 mSecs.

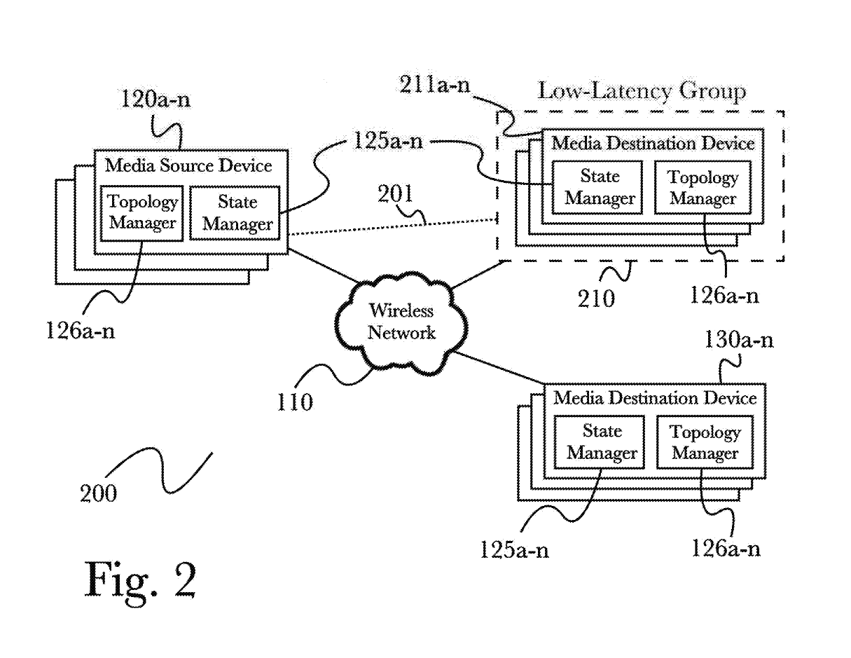

A major delay in the process is how long it takes to detect that a packet is lost. In the case where a preconfigured latency threshold is surpassed, topology manager 126a-n will detect the unacceptable latency and dynamically change the network topology by directing topology managers 126a-n operating on other networked devices, for example instructing devices to communicate directly to form a low-latency group as described below (referring to FIG. 2). In some embodiments, a “low-latency device” may have a lower threshold for acceptable network latency than other devices. This dynamic reconfiguration may be used to adapt to changes in network quality or configuration, such as (for example, including but not limited to) congestion caused by multiple new devices joining the network, bandwidth saturation caused by large downloads or uploads, devices being used for gaming over the network, changes in signal strength due to movement or interference, or changes in connection quality to the Internet (for example, if an ISP experience an outage, or if a modem is configured with multiple WANs that may have different qualities or capabilities, and switches between them).

This invention describes a process/algorithm known as a Loss Anticipation Algorithm (LAA) for keeping this loss detection delay low. In general, a Wi-Fi network will transmit the packets from source to receiver in the order that they were given to the source for transmission. However, in transmission, these packets may be lost, the order of packet transmissions mixed up and each packet may be delayed by an unknown amount of time. The occurrence of these is determined not only by RF or Wi-Fi factors as described above, but also due to implementation issues, such as buffer sizes in the access point and network traffic congestion at that particular moment. By having nodes (for example, media destination devices 130a-n, that are subject to dynamically changing topology), a more efficient network topology may be dynamically selected by topology manager 126a-n to enable high throughput, fault-tolerance, and low delay.

### Detailed Description of Exemplary Embodiments

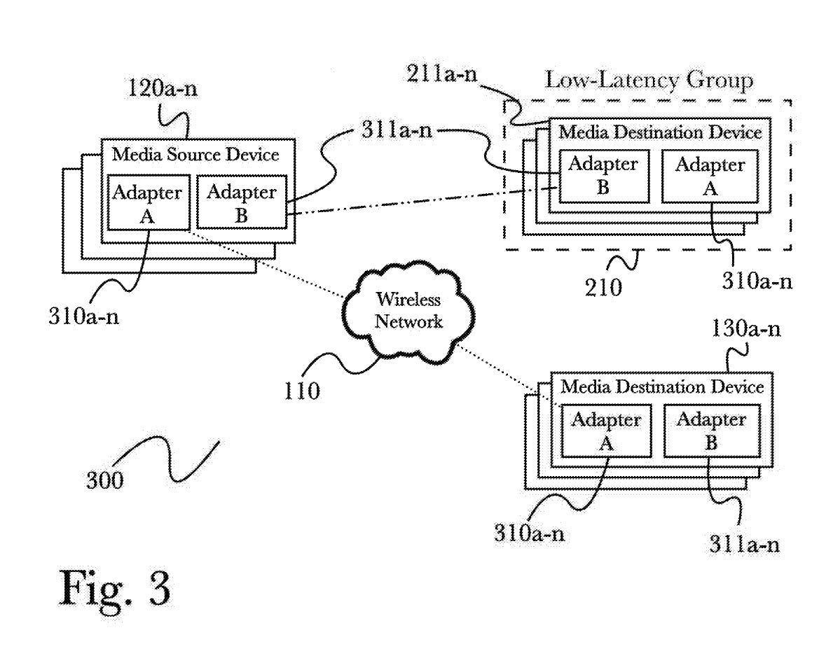

FIG. 2 is an architecture diagram of an exemplary system 200 for dynamic reconfiguration of network topology for low-latency media transmissions according to a preferred embodiment of the invention, illustrating the configuration of a low-latency group 210 within a wireless network. According to the embodiment, a topology manager 126a-n operating on any of a plurality of media source devices 120a-n may monitor network statistics such as traffic, bandwidth saturation, ping, packet loss, or any other measurable indicator of network performance. These statistics may be assigned (either individually or in various combinations) threshold values of acceptability, which when exceeded may prompt a response from topology manager 126a-n. According to the embodiment, if network performance is degraded to an unacceptable level (for example, to a level where it may begin to impact media streaming, such as causing stuttering, buffering, or frame loss), a topology manager 126a-n on a media source device 120a-n may direct topology managers 126a-n on a plurality of media destination devices 211a-n (generally, those affected by or causing the network issues, but arrangements may vary according to the embodiment) to connect to and communicate with a media source 120a-n directly 201, in an ad hoc low-latency group 210 that communicates without the use of the rest of the wireless network (for example, bypassing an access point or router). This both reduces network congestion by removing traffic for the low-latency group 210 from the rest of the network, as well as improving performance for those devices by reducing the number of network “hops” communication must pass through between devices, giving each device 211a-n within a low-latency group 210 a direct line of communication to a media source device 120a-n. Any number of low-latency groups 210 may be configured dynamically as needed, and any particular low-latency group may comprise any number of networked devices 211a-n. In some arrangements, devices 211a-n within a low-latency group 210 may remain connected to a wireless network 110 (for example, using a second wireless adapter, as described below with reference to FIG. 3) while communicating directly with a media source device 120a-n, for example to maintain connectivity to other services such as (for example) cloud-based services or non-media networked services such as to receive software updates and maintain other general functionality uninterrupted. As needed, topology managers 126a-n may reconfigure a low-latency device 211a-n to drop this network connection, for example if the device is still impacting the rest of the network despite using ad hoc communication 201 for media content.

FIG. 3 is an architecture diagram of an exemplary system 300 for dynamic reconfiguration of network topology for low-latency media transmissions according to a preferred embodiment of the invention, illustrating the use of dual network adapters 310a-n, 311a-n to manage a low-latency group 210. According to the embodiment, media source 120a-n and destination 130a-n, 211a-n devices may each operate multiple wireless network adapters 310a-n, 311a-n, and may optionally communicate using one or more adapters according to a current network topology. Generally, a media destination device 130a-n may connect to a wireless network 110 using one wireless adapter “A” 310a-n, while an additional adapter “B” 311a-n remains unused. If a media source 120a-n configures a low-latency group 210, devices 211a-n within the low-latency group 210 may use wireless adapter B 311a-n to communicate directly with a media source 120a-n via its own wireless adapter B 311a-n, while the media source device 120a-n continues to communicate with the rest of the network 110 using its wireless adapter A 310a-n. This approach separates communication not only at the network level but also at the hardware level within each device by utilizing a specific network interface for low-latency communications. It should be noted that there may not necessarily be a technical or functional difference between adapters A 310a-n and B 311a-n and adapters may be used interchangeably as needed, and it should be appreciated that they are illustrated in this manner to more clearly indicate the nature of utilizing one adapter or another preferentially, or using two adapters together for separate simultaneous communication with both a wireless network 110 and a low-latency group 210.

According to the embodiment, a wide variety of hardware arrangements may be utilized to facilitate the operation of dual wireless network adapters 310a-n, 311a-n. For example, a single wireless network hardware controller may operate multiple antennas, as is common in multiple-input and multiple-output (MIMO) hardware arrangements. This is commonly used to increase bandwidth and speed using multipath propagation or spatial multiplexing typically combined with orthogonal frequency-division multiplexing (OFDM) or orthogonal frequency division multiple access (OFDMA), but may also be used to communicate with multiple network hosts or endpoints (such as an access point or router of wireless network 110 and a plurality of media source devices 120a-n, as described above) in a practice known as “multihoming”, for example by utilizing separate antennas to communicate on different wireless radio frequencies or channels.

Another exemplary arrangement may utilize multiple distinct wireless radios each with their own interface controller, for example as is commonly used in mobile device design for smartphones or tablets, or as in a personal computer with multiple network interface controllers (NICs), such as multiple Wi-Fi hardware expansion cards. Mobile devices commonly utilize separate Wi-Fi and cellular radio interfaces, allowing them to connect simultaneously to both local and wide-area networks as needed, for example to improve user experience by reducing network loss while in motion (for example, if a user moves out of range of a Wi-Fi LAN to which they are connected, the mobile device may automatically switch to using a cellular WAN for the network session). When using multiple NICs, software operating on a device 211a-n may process the different connections and optionally virtualize them into a single network by bridging the two connections internally for easier low-latency communication (for example, so that all network endpoints accessible via either NIC are visible to software simultaneously, without needing to select a particular NIC, network, or subnet). It should be appreciated that while reference may be made to particular hardware arrangements for multiple wireless adapters such arrangements are exemplary and provided to describe the overall function in a clear manner, and that a wide variety of arrangements and hardware combinations may be utilized according to the embodiments.

A third exemplary arrangement may be a wireless network interface controller (NIC) that operates a single wireless radio, that is configured to operate on multiple channels within a specific frequency band. This may be accomplished through a variety of multiple-access networking approaches, and enables the use of multiple channels on a single frequency band to communicate with different endpoints. For example, in an 802.11n Wi-Fi network, all communication occurs in the nominal 2.4 GHz frequency band, but multiple channels are available. Utilizing more than one channel may enable a single NIC and radio to communicate independently with multiple access points, or with an access point and a plurality of devices on a different channel, or other complex network arrangements.

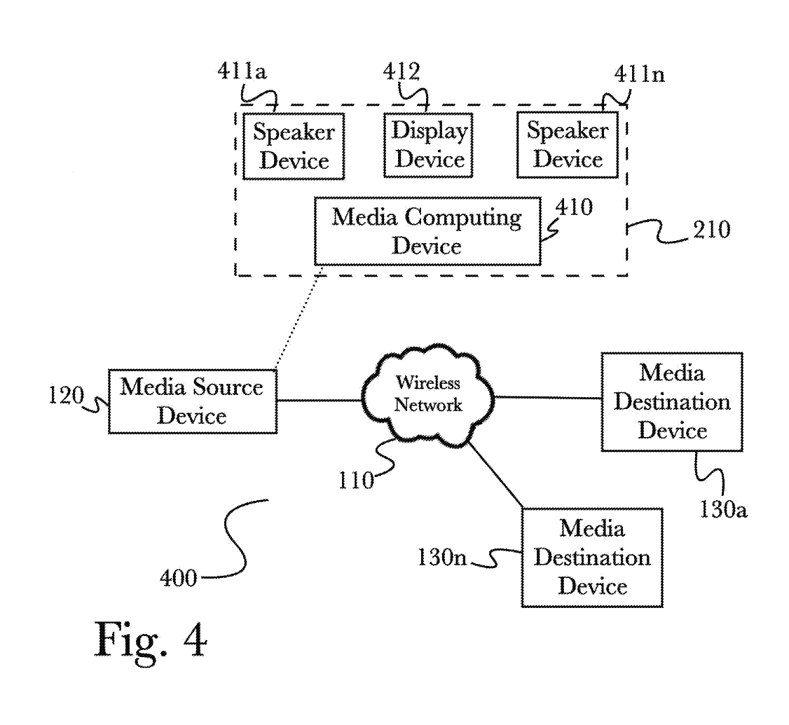

FIG. 4 is an architecture diagram of an exemplary system 400 for dynamic reconfiguration of network topology for low-latency media transmissions according to a preferred embodiment of the invention, illustrating the use of a media computing device 410 and multiple speakers 411a-n as a low-latency group 210 within a home theater arrangement. In a home theater setup, it is common to utilize a media computing device 410 to manage multimedia content for rendering via a plurality of speakers 411a-n and displays 412, such as a television. According to the embodiment, these home theater devices may be configured as a low-latency group 210 communicating directly with a media source device 120 such as (for example) a mobile device that is streaming content to a television 412, or a network storage device that stores and provides media for use by media computing device 410. In this manner, the home theater setup may enjoy low-latency network communication without being impacted by other devices on a network 110.

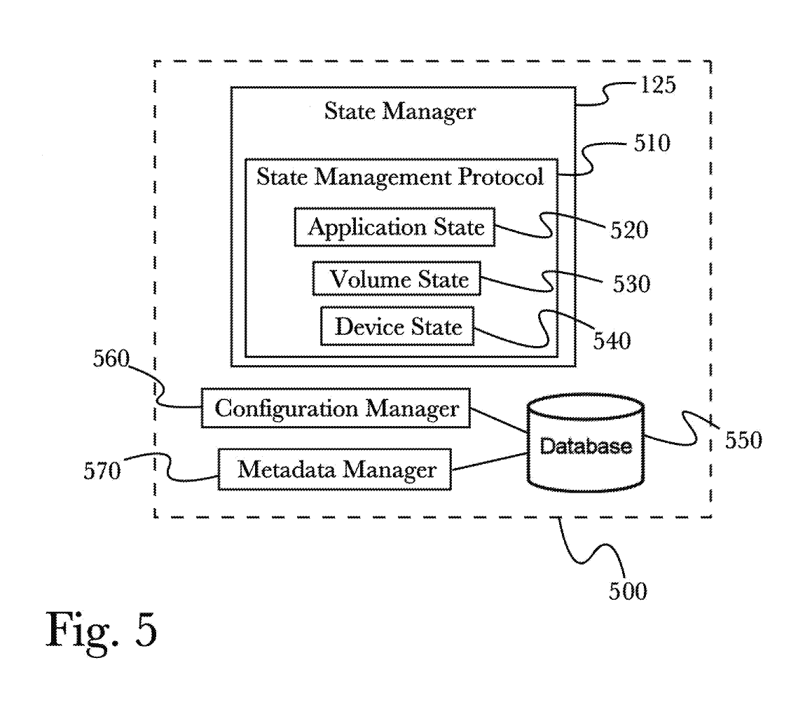

FIG. 5 is a block diagram illustrating an architecture for a state manager 125 configured to manage application states. State manager 125 of a media source device 120a-n (referring to FIG. 1, above) may be used to manage the state and any changes thereof for a connected device, which may be either a media source device 120a-n or a media destination device 130a-n, or both, according to its capabilities or current operation. State manager 125 may store the status of some or all connected devices at any given time and may receive state messages from connected devices. Received state messages may be processed and used to direct changes in state or cause an action or output to take place for any given change in device state. Device state may be communicated using state protocol messages generated according to a state management protocol 510 that may specify a variety of messages types or values (such as specific data to be provided within or associated with a particular message type, for example), for example, application state 520 may store the status of applications that are running on connected devices, volume control state 530 may store the state of connected devices that may require a volume adjustment if a volume adjustment request is received from a media source device 120a-n or a destination device 130a-n. Device state 540 may store state information for some or all connected devices or known configured devices that are not currently connected (for example, devices that may be known but are currently unavailable due to network connectivity, power state, or other issues). Known devices and device-related information may be stored for retrieval and use in a database 550. Configuration manager 560 may be used to store and manage configuration of a device operating state manager 125 or, optionally, of other known devices (as may be obtained from device database 550). Information in database 550 may include, but is not limited to, device hardware capabilities, network connection information, associated devices (for example, devices paired to a smartphone via BLUETOOTH™), media information, metadata, or other device-specific or media information. Metadata manager 570 may be used to retrieve, modify, or transmit metadata as described above (with reference to FIG. 1), for use or presentation at a receiving connected device

In low latency situations, especially when media is being played back, even small disruptions in network transmission to one or more destination devices 130a-n may be especially noticeable. While wireless networks suffer from the same congestion related issues as wired networks, using radio technology, they are also significantly affected by environmental interference which may drastically degrade network performance, leading to lost packets and high latency symptoms such as dropouts, sound distortions and loss of synchronization of one or more render devices. The invention includes processes to greatly diminish these wireless network issues. According to the embodiments, latency is greatly reduced by enabling a source device 120a-n to transmit directly to a plurality of destination devices 130a-n as previously described. However, transient or more long lasting factors, for example including (but not limited to) another radio source, a radio opaque obstacle, or a change in the position of the recipient device's antenna may prevent reliable reception by one or more devices. A topology manager 126a-n employs measures to rapidly identify packet loss issues indicative of network issues throughout media playback and to rapidly test then change the topology of the playback network to restore efficient, low latency network traffic from the source device 120a-n to destination devices 130a-n with minimal observable detrimental effect on ongoing playback quality.

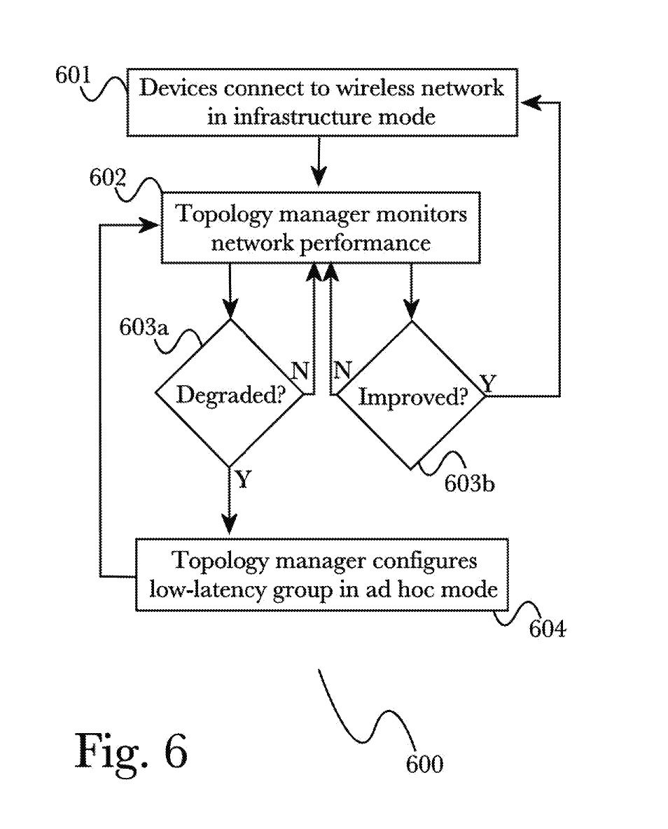

FIG. 6 is a flow diagram illustrating an exemplary method 600 for dynamic reconfiguration of network topology for low-latency media transmissions according to a preferred embodiment of the invention. In an initial step 601, a plurality of devices may connect to a wireless network in infrastructure mode, using an access point such as a wireless router to manage the network with all devices communicating through the access point. In a next step 602 a topology manager 126 operating on one of the devices (such as a media source device 120a-n) may monitor the network performance, such as monitoring bandwidth usage, packet loss, signal strength, ping times, and other network statistics. If network performance becomes degraded 603a for one or more devices, the topology manager 126 may then configure 604 a low-latency group 210 for the affected devices and direct them to begin operating in ad hoc mode communicating directly with one another (for example, media destinations devices 130a-n receiving media directly from a media source 120a-n, as described above with reference to FIG. 2), and continue monitoring 602. If network performance improves 603b, the topology manager 126 may reconfigure devices to resume operating in infrastructure mode 601, and continue monitoring for future changes 602. In this manner, network configuration may be dynamically modified in a continuous fashion as directed by topology manager 126 to ensure that all devices are operating optimally.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

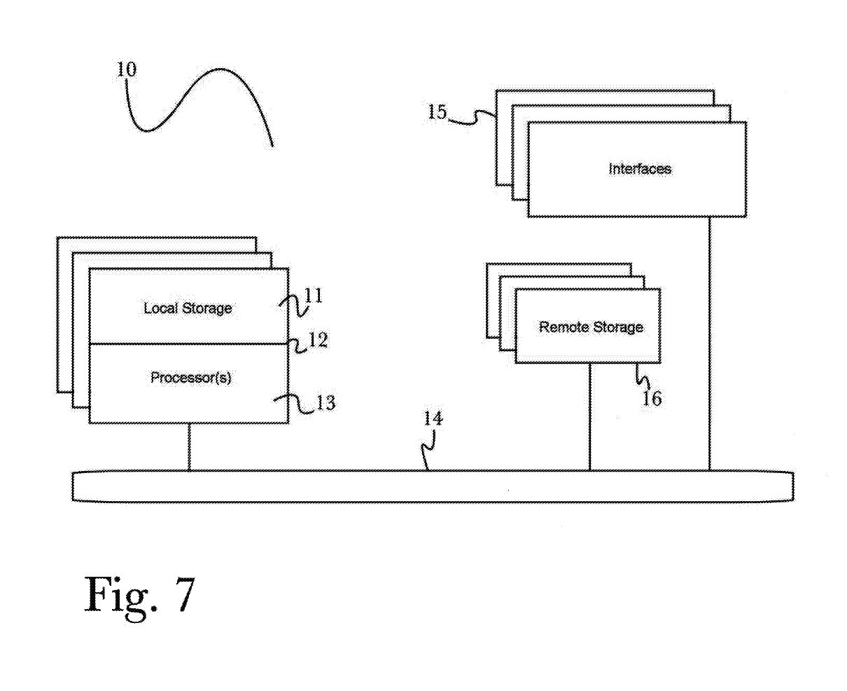

Referring now to FIG. 7, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (Wi-Fi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 7 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

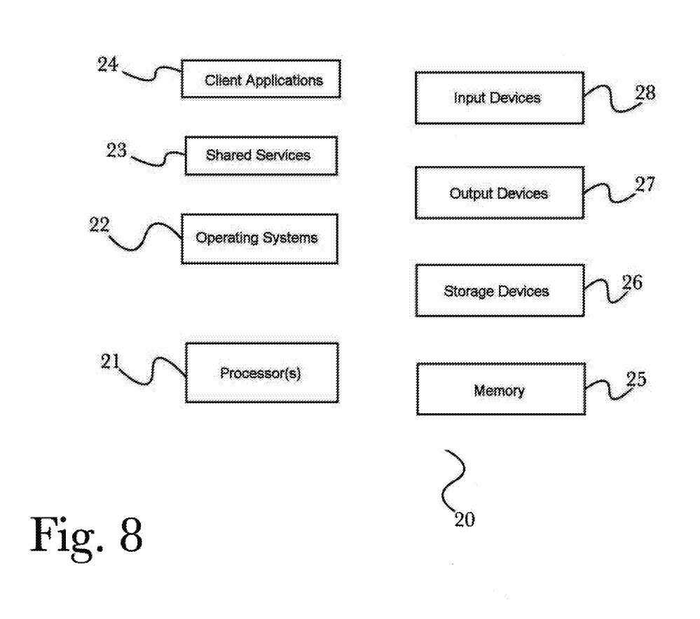

In some embodiments, systems according to the present invention may be implemented on a standalone computing system. Referring now to FIG. 8, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 7). Examples of storage devices 26 include flash memory, magnetic hard drive, CD-ROM, and/or the like.

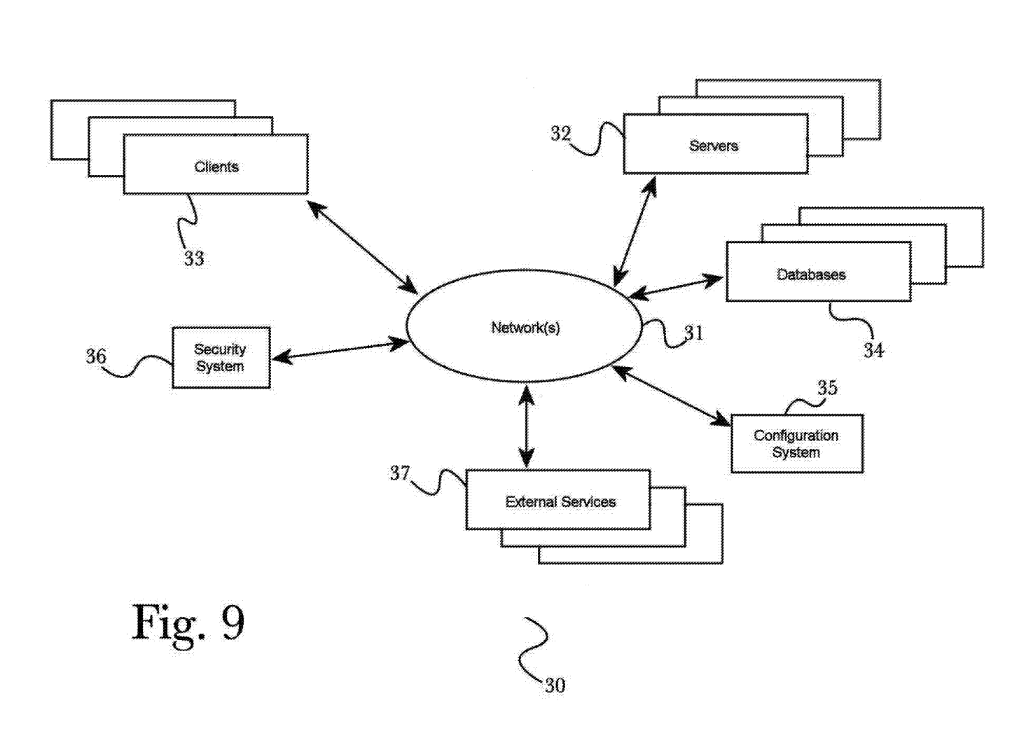

In some embodiments, systems of the present invention may be implemented on a distributed computing network, such as one having any number of clients and/or servers. Referring now to FIG. 9, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 8. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as Wi-Fi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

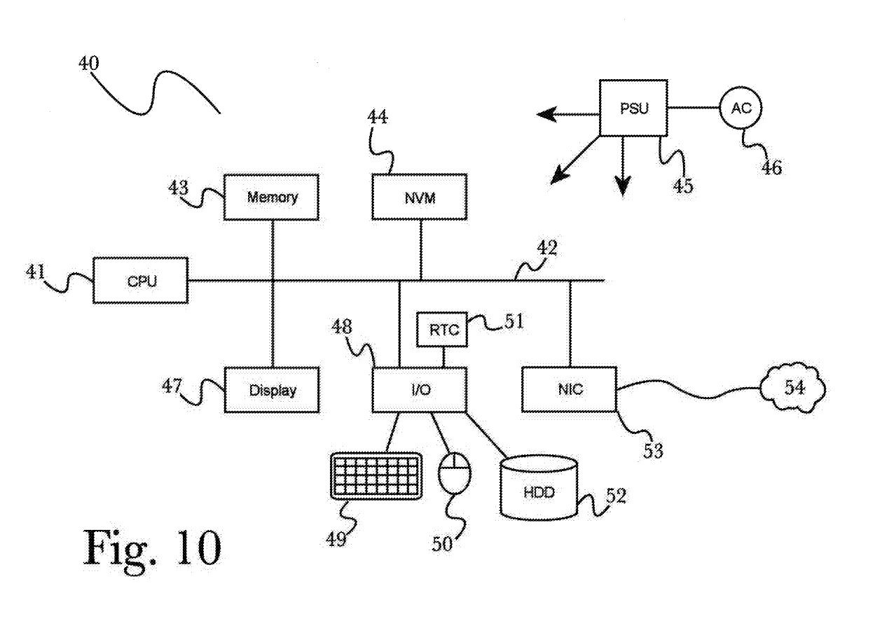

FIG. 10 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

What is claimed is:

1. A system for dynamic reconfiguration of network topology for low-latency media transmissions, comprising:
a topology manager comprising at least a plurality of programming instructions stored in a memory and operating on a processor of a network-connected computing device and configured to monitor a plurality of performance metrics of at least a wireless network, and configured to direct the operation of at least a wireless network interface, and configured to communicate with a plurality of external devices via the wireless network interface;
wherein the topology manager directs the wireless network interface to operate in infrastructure mode if the monitored performance metrics do not exceed a quality-of-service threshold; and
wherein the topology manager directs the wireless network interface to operate in ad hoc mode if at least a portion of the monitored performance metrics exceed a quality-of-service threshold.

2. A method for dynamic reconfiguration of network topology for low-latency media transmissions, comprising the steps of:
monitoring, using topology manager comprising at least a plurality of programming instructions stored in a memory and operating on a processor of a network-connected computing device and configured to monitor a plurality of performance metrics of at least a wireless network, and configured to direct the operation of at least a wireless network interface, and configured to communicate with a plurality of external devices via the wireless network interface, a plurality of network performance metrics for a wireless network;
determining whether any of the monitored performance metrics exceed a quality-of-service threshold; and
if a quality-of-service threshold is exceeded, directing at least the wireless network interface to operate in ad hoc mode.
